(19) United States
(12) Patent Application Publication
(10) Pub. No.: US 2014/0299108 A1
(43) Pub. Date: Oct. 9, 2014

(54) IC ENGINE CYLINDER AND PISTON

(71) Applicants: Grzegorz Siuchta, Des Plaines, IL (US); Dean Alan Oppermann, Plainfield, IL (US)

(72) Inventors: Grzegorz Siuchta, Des Plaines, IL (US); Dean Alan Oppermann, Plainfield, IL (US)

(73) Assignee: International Engine Intellectual Property Company LLC, Lisle, IL (US)

(21) Appl. No.: 14/354,072

(22) PCT Filed: Apr. 16, 2012
(86) PCT No.: PCT/US12/33793

§ 371 Date: Apr. 24, 2014

Related U.S. Application Data
(60) Provisional application No. 61/560,882, filed on Nov. 17, 2011.

(51) Int. Cl. F02F 3/28

(52) U.S. Cl. CPC F02F 3/28
USPC 123/48 AA

(57) ABSTRACT

A cylinder head has a plunger receptacle and a piston has a plunger which, when the piston is reciprocating within an engine cylinder over an engine cycle range between BDC and an intermediate position spaced from both TDC and BDC, exposes the plunger receptacle to the interior of the engine cylinder, but which, when the piston is reciprocating over an engine cycle range between the intermediate position and TDC position, closes the plunger receptacle to the interior of the engine cylinder. A fuel/air charge is created within the engine cylinder, compressed to higher compression ratio in the plunger receptacle at TDC position where it is ignited and then used to ignite the lower compression ratio charge in the engine cylinder.

### FIELD

The subject matter of the present disclosure relates generally to an internal combustion engine of the type having engine cylinders within which pistons reciprocate. The disclosed subject matter relates particularly to an engine cylinder and a piston which, as the latter is approaching top dead center (TDC) position, cooperate in forming variable volume first and second combustion chamber spaces which are isolated from each other and which have different compression ratios at TDC position.

### BACKGROUND

When a power plant of a motor vehicle is a spark-ignited internal combustion engine, one of the controls for the engine is a throttle in the intake system. Throttling of the engine enables it to operate at speeds and torques which are less than the maximum speed and maximum torque which the engine is capable of attaining. However, when the engine is running at part throttle, the throttle imposes a restriction which contributes to engine inefficiency due to engine pumping losses.

In certain engines, the throttle can be controlled in conjunction with control of fueling to create in-cylinder fuel/air charges which have substantially stoichiometric fuel/air ratios, a feature which may be useful for exhaust after-treatment.

Certain engines, such as those which use natural gas as a primary fuel (NG engines), operate at lean or stoichiometric with exhaust gas recirculation (EGR). The presence of excess oxygen or EGR in a fuel/air charge tends to render the charge difficult to ignite. To assure charge ignition, it is known to create a precombustion chamber space within an engine cylinder into which fuel, which may be other than natural gas (diesel fuel, for example) is injected to create a localized rich mixture which is more easily ignited to initiate combustion of the lean mixture in the cylinder. An NG, spark-ignited (SI), engine operating at lean air/fuel mixtures (Air/Fuel ratio above stoichiometric ratio) or an NG, SI, engine operating at stoichiometric ratio of air/fuel mixtures diluted with higher EGR levels can offer improved engine performance and efficiency, but such mixtures are difficult to ignite.

An engine which runs with little or no exhaust gas recirculation, such as an NG engine, tends to be prone to combustion knock which in the case of a turbocharged engine limits engine boost and hence affects engine performance.

### SUMMARY OF THE DISCLOSURE

The disclosed internal combustion engine comprises an engine cylinder which has a lengthwise extending central axis and within an interior of which combustion occurs to power the engine, a cylinder head closing an axial end of the engine cylinder, and a piston which, during engine cycles, reciprocates axially within the engine cylinder between TDC position and BDC position and which comprises a piston head confronting the cylinder head.

The cylinder head and the piston collectively comprise a plunger receptacle in one of the cylinder head and the piston, and in the other of the cylinder head and the piston, a plunger which, when the piston is reciprocating over an engine cycle range between BDC position and an intermediate position spaced from both TDC position and BDC position, exposes the plunger receptacle to the interior of the engine cylinder, but which, when the piston is reciprocating over an engine cycle range between the intermediate position and TDC position, closes the plunger receptacle to the interior of the engine cylinder to form a variable volume first combustion chamber space cooperatively defined between the plunger and the plunger receptacle and isolated from a variable volume second combustion chamber space which is axially bounded by mutually confronting surfaces of the cylinder head and the piston head which exclude the plunger receptacle and the plunger.

The collective geometry of the engine cylinder, the piston, the cylinder head, the plunger receptacle and the plunger provide, at TDC position, a compression ratio for the first combustion chamber space which is greater than a compression ratio for the second combustion chamber space.

### BRIEF DESCRIPTION OF THE DRAWINGS

FIG. 1 is a diagram of a portion of an internal combustion engine which shows an engine cylinder and a piston which reciprocates within the engine cylinder between BDC position and TDC position.

FIG. 2 is a diagram like FIG. 1, but showing the piston in a position intermediate to the BDC position and the TDC position.

FIG. 3 is a diagram like FIG. 2, but showing the piston in TDC position.

### DETAILED DESCRIPTION

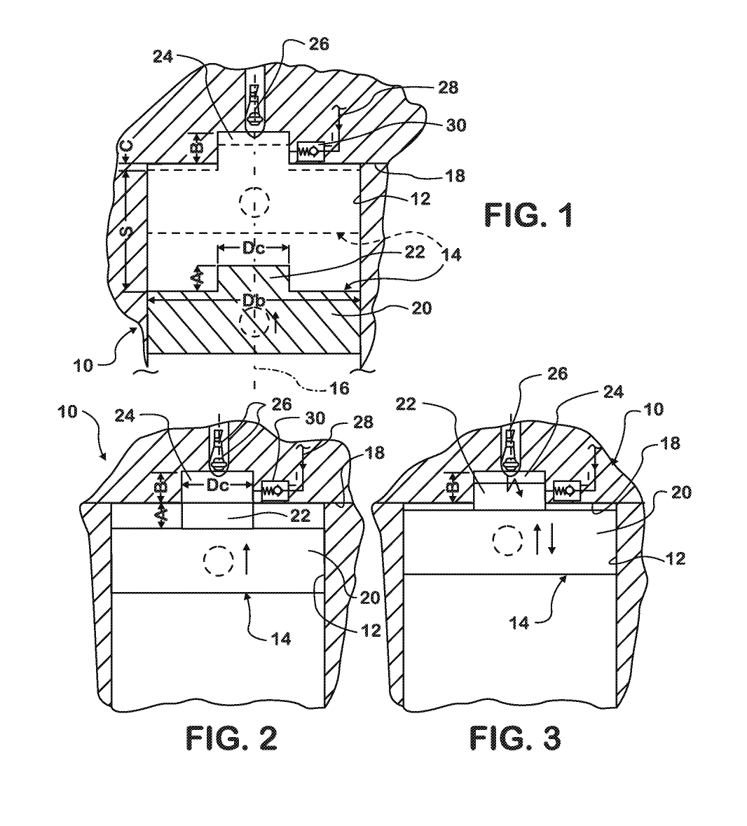

FIG. 1 shows a portion of an internal combustion engine 10 which may be used as the powerplant of a motor vehicle such as a truck (not shown in the drawing) for propelling the motor vehicle.

Engine 10 comprises multiple engine cylinders 12, like the single one illustrated, within the interior of each of which a respective piston 14 reciprocates. Certain other components which are present, such as cylinder intake and exhaust valves for example, are not illustrated.

Engine cylinder 12 has a lengthwise extending central axis 16 and an interior within which combustion occurs to power the engine. Engine 10 comprises a cylinder head 18 which closes an axial end of engine cylinder 12. Piston 14 reciprocates axially within engine cylinder 12 between TDC position (shown in broken lines) and BDC position (shown in solid lines) and comprises a piston head 20 confronting cylinder head 18.

Piston 14 comprises a plunger 22 which is coaxial with axis 16 and which extends axially outward from a top surface of piston head 20 which confronts a mutually confronting surface of cylinder head 18. Plunger 22 has a circular cylindrical side surface and a flat end surface which is perpendicular to the side surface, although the end surface may have a shape other than flat, such as a concave or a convex shape.

Cylinder head 18 comprises a plunger receptacle 24 which is coaxial with axis 16 and which extends axially inward from the surface of cylinder head 18 which confronts piston head 20. Plunger receptacle 24 has a circular cylindrical side surface and a flat end surface which is perpendicular to the side surface although the end surface may have a shape other than flat.

When piston 14 is reciprocating over an engine cycle range between BDC position and an intermediate position (shown in FIG. 2) spaced from both TDC position and BDC position, plunger receptacle 24 is exposed to the interior of engine cylinder 12. When piston 14 is reciprocating over an engine cycle range between the intermediate position shown in FIG. 2 and TDC position, plunger 22 closes plunger receptacle 24 to the interior of engine cylinder 12 to form a variable volume first combustion chamber space which is cooperatively defined between plunger 22 and plunger receptacle 24 and which is isolated from a variable volume second combustion chamber space within the interior of engine cylinder 12, the second combustion chamber space being axially bounded by the mutually confronting surfaces of cylinder head 18 and piston head 20 which exclude plunger receptacle 24 and plunger 22.

When the position of piston 14 is within the engine cycle range between BDC position and the intermediate position, a fuel/air charge is created within engine cylinder 12, including plunger receptacle 24. The fuel/air charge can be created in any suitably appropriate way. As piston 14 upstrokes toward the intermediate position, it uniformly compresses the fuel/air charge.

As piston 14 continues to upstroke, it passes through the intermediate position at which plunger 22 begins to enter plunger receptacle 24, closing the plunger receptacle to the interior of engine cylinder 12. This isolates the first and second combustion chamber spaces from each other, trapping the portion of the fuel/air charge in plunger receptacle 24.

The arrival of piston 14 at the intermediate position defines a corresponding compression ratio for engine cylinder 12. As piston 14 continues to upstroke over the engine cycle range from the intermediate position toward TDC position the side surfaces of plunger 22 and plunger receptacle 24 radially confront each other with a close sliding fit to cause the portion of the charge trapped by plunger 22 in plunger receptacle 24 to be further compressed while the portion of the charge remaining within the interior of engine cylinder 12 is also further compressed, but at a different rate of compression from the rate at which the trapped charge in plunger receptacle 24 is being compressed. In the example which will be explained shortly, the rate of compression of the charge trapped in plunger receptacle 24 is greater than the rate at which the charge within the interior of engine cylinder 12 is being compressed.

The collective geometry of engine cylinder 12, piston 14, cylinder head 18, plunger receptacle 24, and plunger 22 provide, at TDC position shown in FIG. 3, a compression ratio for the charged trapped in the first combustion chamber space which is greater than a compression ratio for the charge within the interior of engine cylinder 12 facing the second combustion chamber space.

Engine 10 also comprises an igniter, such as a conventional automotive spark plug 26, for creating an igniting spark in the first combustion chamber space to ignite the charge trapped in plunger receptacle 24 by plunger 22. The igniter is considered an optional device whose presence or absence is conditioned on specific cylinder/piston configuration and particular fuel combusted.

Engine 10 also comprises a fuel supply passage 28 which is open to the first combustion chamber space and through which fuel can be introduced into the first combustion chamber space. Fuel supply passage 28 comprises a check 30 for preventing backflow from the first combustion chamber space to a portion of the fuel supply passage upstream of the check. Fuel supply passage 28 opens to the first combustion chamber space at a location which is occluded by plunger 22 as piston 14 is reciprocating over an engine cycle range between TDC position and a position between the intermediate position shown in FIG. 2 and TDC position shown in FIG. 3. It is to be appreciated that certain engines are capable of igniting highly diluted cylinder charges without the use of additional fuel supplied by a fuel supply passage 28, thereby rendering the use of fuel supply passage 28 optional in such engines.

A specific example is given by dimensions marked in the Figures where S is the stroke of piston 14 as measured between BDC position and TDC position; Db is the diameter of piston head 20, Dc is the diameter of plunger 22, A is the axial length of plunger 22, B is the axial length of plunger receptacle 24, and C is the axial distance between the mutually confronting surfaces of piston head 20 and cylinder head 18 when piston 14 is at TDC position.

The compression ratio (CR1) at the intermediate position of piston 14 shown in FIG. 2 is given by the following formula:

CR1=((C+S*Db²+(B−A)*Dc²)/(B*Dc²)+A*(Db−Dc)²

The compression ratio (CRp) in the first combustion chamber space when piston 14 is at TDC position is given by the following formula:

CRp=CR1*B/(B+C−A)

The compression ratio CRm in the second combustion chamber space when piston 14 is at TDC position is given by the following formula:

CRm=CR1*(A/C)

For values of S=119 mm., Db=116 mm., A=23 mm., B=9 mm., and Dc=23 mm., which are representative dimensions for an 1466 Diesel engine converted into an NG engine, CR1=˜9, CRp=˜14, and CRm=˜11.

The more compressed charge trapped in plunger receptacle 24, when ignited by either autoignition or electric spark, provides increased reactivity, with or without extra fueling from fuel supply passage 28, which facilitates its subsequent ignition of the lower reactivity charge within engine cylinder 12 upon plunger 22 leaving plunger receptacle 24. The perimeter rim of plunger 22 may however have a shape other than circular; for example it may be castellated to provide small cuts through which flame jets resulting from ignition of the compressed charge in plunger receptacle 24 can pass to cause ignition of the portion of the mixture in the second combustion chamber space prior to plunger 22 leaving plunger receptacle 24.

The subject matter of this disclosure can endow an SI IC engine with reliable ignition and combustion of very lean and/or highly diluted with EGR, air/fuel (Natural Gas) mixtures. The engine may operate with a higher EGR rate and cooler EGR, enabling it to have a larger compression ratio for better engine performance and efficiency with lower exhaust temperatures. Intake throttle usage may be eliminated or reduced to mitigate pumping losses. Knock combustion may be eliminated or reduced. Reductions in spark energy for mixture ignition may improve spark plug durability.

What is claimed is:

1. An internal combustion ignition engine comprising:
an engine cylinder which has a lengthwise extending central axis and within an interior of which combustion occurs to power the engine;
a cylinder head closing an axial end of the engine cylinder;
a piston which, during engine cycles, reciprocates axially within the engine cylinder between TDC position and BDC position and which comprises a piston head confronting the cylinder head;
the cylinder head and the piston collectively comprising a plunger receptacle in one of the cylinder head and the piston, and in the other of the cylinder head and the piston, a plunger which, when the piston is reciprocating over an engine cycle range between BDC position and an intermediate position spaced from both TDC position and BDC position, exposes the plunger receptacle to the interior of the engine cylinder, but which, when the piston is reciprocating over an engine cycle range between the intermediate position and TDC position, closes the plunger receptacle to the interior of the engine cylinder to form a variable volume first combustion chamber space which is cooperatively defined between the plunger and the plunger receptacle and which is isolated from a variable volume second combustion chamber space which is axially bounded by mutually confronting surfaces of the cylinder head and the piston head which exclude the plunger receptacle and the plunger; and
the collective geometry of the engine cylinder, the piston, the cylinder head, the plunger receptacle and the plunger providing, at TDC position, a compression ratio for the first combustion chamber space which is greater than a compression ratio for the second combustion chamber space.

2. The internal combustion engine as set forth in claim 1 in which the plunger extends axially outward from the mutually confronting surface of the piston head and the cavity extends axially inward from the mutually confronting surface of the cylinder head.

3. The internal combustion engine as set forth in claim 2 in which the plunger and the plunger receptacle comprise respective circular cylindrical side surfaces which radially confront each other as the piston is reciprocating over the engine cycle range between the intermediate position and TDC position.

4. The internal combustion engine as set forth in claim 3 in which the plunger and the plunger receptacle are coaxial with the central axis.

5. The internal combustion engine as set forth in claim 4 further comprising an igniter for creating an igniting spark in the first combustion chamber space.

6. The internal combustion engine as set forth in claim 4 further comprising a fuel supply passage which is open to the first combustion chamber space and through which fuel can be introduced into the first combustion chamber space.

7. The internal combustion engine as set forth in claim 7 in which the fuel supply passage comprises a check for preventing backflow from the first combustion chamber space to a portion of the fuel supply passage upstream of the check.

8. The internal combustion engine as set forth in claim 7 in which the fuel supply passage opens to the first combustion chamber space at a location which is occluded by the plunger as the piston is reciprocating over an engine cycle range between TDC position and a position between the intermediate position and TDC position.

9. The internal combustion engine as set forth in claim 1 in which the collective geometry of the engine cylinder, the piston, the cylinder head, the plunger receptacle and the plunger provides for compression in the first combustion chamber space to increase at a rate which is greater than the rate at which compression in the second combustion chamber space increases when the piston is upstroking over the engine cycle range between the intermediate position and TDC position.

10. A method of operating the internal combustion engine set forth in claim 1 comprising creating a fuel/air charge in the engine cylinder, including the plunger receptacle, when piston position is within the engine cycle range between BDC position and the intermediate position, compressing the fuel/air charge as the piston upstrokes toward the intermediate position, and then when the piston upstrokes over the engine cycle range between the intermediate position and TDC position, compressing a portion of the fuel/air charge in the first combustion chamber space at a first rate of compression and compressing a portion of the fuel/air charge in the second combustion chamber space at a second rate of compression which is less than the first rate of compression.

11. The method of operating the internal combustion engine set forth in claim 2 comprising creating a fuel/air charge in the engine cylinder, including the plunger receptacle, when piston position is within the engine cycle range between BDC position and the intermediate position, compressing the fuel/air charge as the piston upstrokes toward the intermediate position, and then when the piston upstrokes over the engine cycle range between the intermediate position and TDC position, compressing a portion of the fuel/air charge in the first combustion chamber space at a first rate of compression and compressing a portion of the fuel/air charge in the second combustion chamber space at a second rate of compression which is less than the first rate of compression.

12. The method of operating the internal combustion engine as set forth in claim 11 further comprising causing ignition of the fuel/air charge in the first combustion chamber space when piston position is within the engine cycle range between the intermediate position and TDC position, and then causing the ignited fuel/air charge to ignite the fuel/air charge in the second combustion chamber space.

13. The method of operating the internal combustion engine as set forth in claim 12 further comprising introducing fuel into the first combustion chamber space through a fuel inlet to the plunger receptacle when piston position is within the engine cycle range between the intermediate position and TDC position.
